(19) United States
(12) Patent Application Publication
(10) Pub. No.: US 2025/0041632 A1
(43) Pub. Date: Feb. 6, 2025

(54) EMERGENCY ESCAPE BREATHING DEVICE FOR USE IN FIRE GROUND

(71) Applicant: HAN-PING LIN, Changhua City (TW)

(72) Inventor: HAN-PING LIN, Changhua County (TW)

(21) Appl. No.: 18/779,866

(22) Filed: Jul. 22, 2024

(30) Foreign Application Priority Data
Aug. 4, 2023 (TW) 112129367

(51) Int. Cl. A62B 7/04; A62B 7/10

(52) U.S. Cl. CPC A62B 7/04; A62B 7/10

(57) ABSTRACT

The present invention relates to an emergency escape breathing device for use in a fire ground, provided as an emergency life-saving apparatus and comprising an exhalation valve and a suction valve configured inside a main body. In addition, a biting piece is connected on the main body for biting by the mouth of a person, and an extension tube is connected to the main body for breathing clean air from the outside. Through the interactive operation of the exhalation valve and the suction valve provided by the present invention, the user can breathe smoothly and avoid repeated intake of carbon dioxide exhaust gas.

### BACKGROUND OF INVENTION

### 1. Field of the Invention

The present invention relates generally to an emergency life-saving apparatus, and more particularly to an emergency escape breathing device for use in a fire ground.

### 2. Description of Related Art

Recently, a series of fire disasters happened in business buildings and factories, and many people died of toxic smoke. Although the rescue work by fire fighters was a race against time to save lives, many people still died because the burning plastic decorations, furniture and equipment can generate a mixture of various toxic gases and smoke, which can quickly kill people. Therefore, it has been proved that providing relatively clean air for people in the fire ground till they are rescued is of vital importance.

A prior-art disclosure in Taiwan Utility Model TWM489651 “ESCAPE MASK” is also an apparatus for timely life-saving in fire grounds. However, an air-tight pad must be fitted between the mask and the face to prevent intake of dense smoke. Apart from high production cost, it has the following problem: as the mask is configured with only one check valve and one exhaust hole, there will be interference between the nose and the mouth when the user inhales and exhales, causing repeated intake of carbon dioxide exhaust gas. Therefore, when using the prior-art product, the user escaping from the fire ground will still intake dense smoke or repeatedly inhale carbon dioxide exhaust gas, causing difficulty in breathing to affect the user's ability to escape from the fire ground.

### SUMMARY OF THE INVENTION

In view of the above-mentioned urgent need for devices that can be used in fire grounds for timely lift-saving, the inventor of the present invention spent great effort in developing the present invention. Therefore, the main object of the present invention is to provide an emergency escape breathing device for timely life-saving; a secondary object of the present invention is to provide an emergency escape breathing device for application in multiple circumstances; and a further object of the present invention is to provide an emergency escape breathing device with few components for easy assembly and production.

To accomplish the above objects, the present invention adopted the following technical means by providing: a main body, configured with a first passage and a second passage, wherein the first passage and the second passage are both connected to an intersection, and a first connecting hole is configured inside the outer end of the first passage, and a second connecting hole is configured inside the second passage at a position adjacent to the intersection; a biting piece, connected to inner end of the first passage of the main body, for the mouth of the user to bite and grip; an extension tube, connected to the outer end of the second passage of the main body, for extension to the outside to breathe clean air from an area without dense smoke; an exhalation valve, connected to the outer end face of the first connecting hole of the main body, to open/close the first passage, i.e., open the first passage when the user exhales, and close the first passage when the user inhales; and a suction valve, connected to the inner end face of the second connecting hole of the main body, to open/close the second passage, i.e., open the second passage when the user inhales, and close the second passage when the user exhales.

Specifically, a flexible tube is configured between the extension tube and the outer end of the second passage of the main body.

Specifically, when the main body is implemented as an integrally formed single body, firstly the suction valve can be placed in from an inner opening of the first passage, and then the suction valve can be mounted on the inner end face of the second connecting hole; and the main body is integrally formed through injection molding using a transparent plastic material.

Based on the above, the present invention adopting the aforementioned technical means can achieve the following effects:
1. The present invention provides a wearable breathing device for use when escaping from a fire ground. Through the two neighboring check vales inside the main body configured in opposite directions, the escaping person can breathe smoothly in the fire ground full of smoke, and can avoid repeated intake of carbon dioxide exhaust gas. By avoiding intake of the dense smoke, the person can manage to escape or stay longer to be rescued.
2. The extension tube of the present invention can be extended to an area without dense smoke to breathe clean air, i.e., it can be extended to the indoor space of the fire ground below the waist and up the floor, or out of the window of the building of the fire ground, or even to the equipped indoor pipes of the building of fire ground indoor, such as water drainage pipes and air exhaust pipes etc.
3. The components of the present invention are very few, and can be easily assembled to save production cost. When the main body is implemented as an integrally formed single body, it can be integrally formed through injection molding using a transparent plastic material so that the suction valve can be easily mounted on the second connecting hole.

### BRIEF DESCRIPTION OF THE DRAWINGS

FIG. 1 is a perspective view of the present invention.

FIG. 2 is a partial exploded view of the present invention.

FIG. 3 is a partial combined sectional view of the present invention.

FIG. 4 is a schematic diagram of the valve structure of the present invention.

FIG. 5 is an operational diagram of the two valves of the present invention.

FIG. 6 is another operational diagram of the two valves of the present invention.

FIG. 7 is an implementation view of the present invention in an indoor fire ground with light dense smoke.

FIG. 8 is an implementation view of the present invention in an indoor fire ground with heavy dense smoke.

FIG. 9 is an implementation view of the present invention in an indoor fire ground and at a position close to the window.

FIG. 10 is an implementation view of the present invention in an indoor fire ground and at a position close to the drainage pipe.

### DETAILED DESCRIPTION OF THE INVENTION

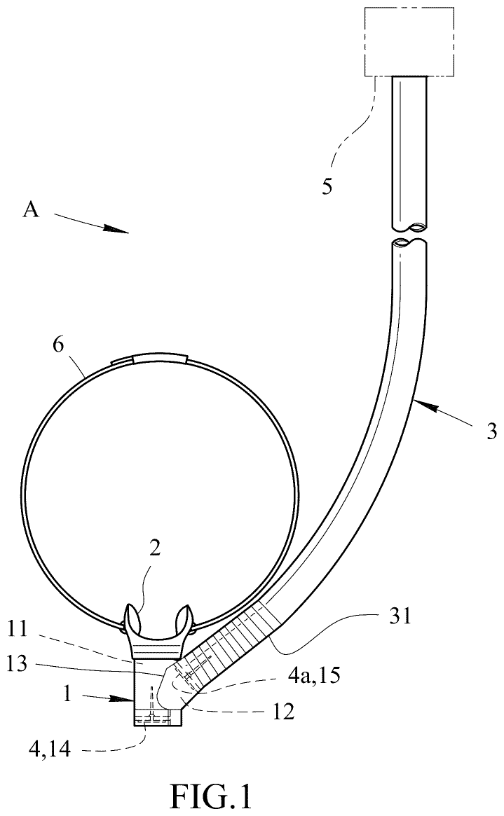

Please refer to FIG. 1. The present invention relates to an emergency escape breathing device for use in a fire ground A, mainly provided as an emergency life-saving apparatus, comprising: a main body 1, a biting piece 2, an extension tube 3, an exhalation valve 4, and a suction valve 4a. The aforementioned components are described in detail below with reference to the accompanying drawings.

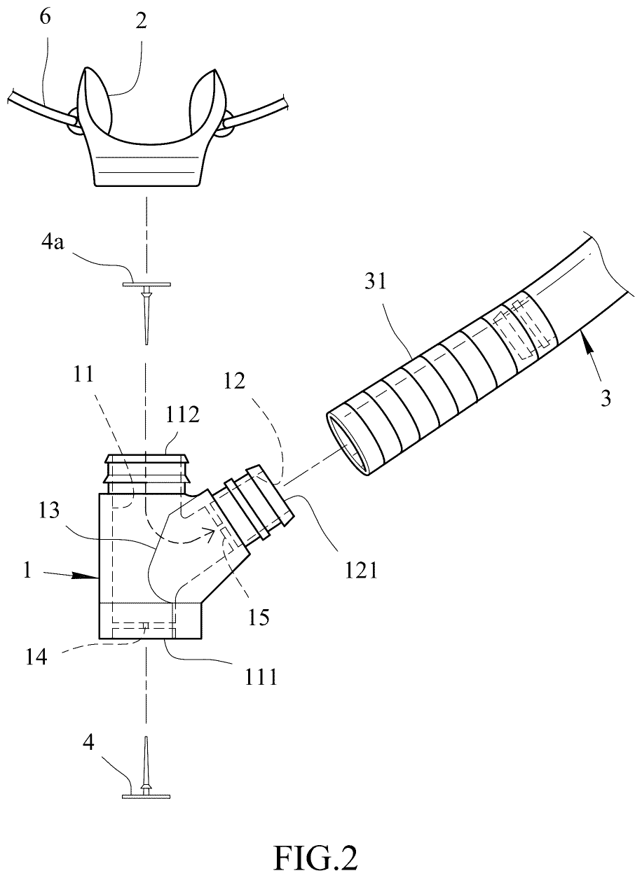

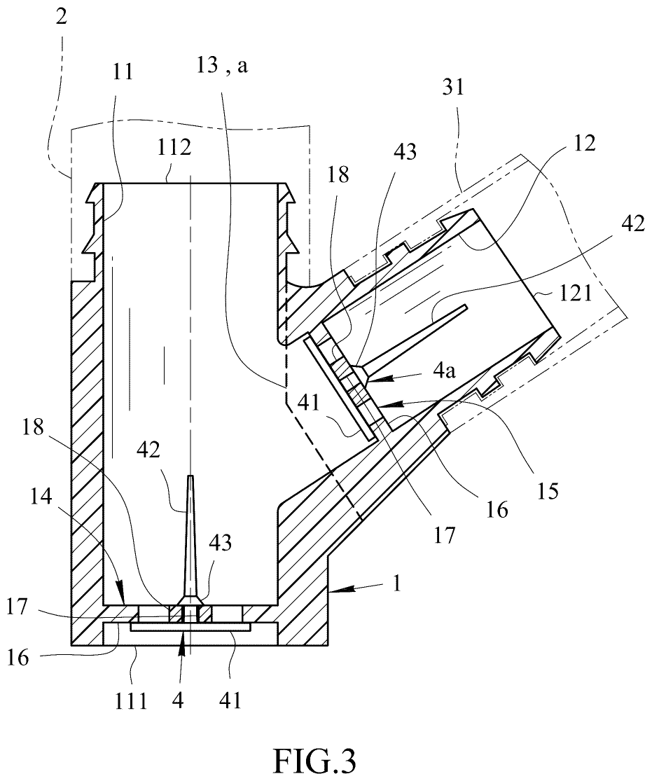

As shown in FIG. 2 and FIG. 3, the inside of the main body 1 is integrally formed with a first passage 11 and a second passage 12, wherein the first passage 11 and the second passage 12 are both formed on an intersection 13, and the main body 1 is not limited to an integrally formed single body, and can be made up of two components joined together through adhesion or threaded connection to form the first passage 11 and the second passage 12. For example, the dashed line in FIG. 3 indicates the joint face a between the two components. In addition, a head strap 6 can be attached to the two sides of the main body 1 for wearing on the head of a person.

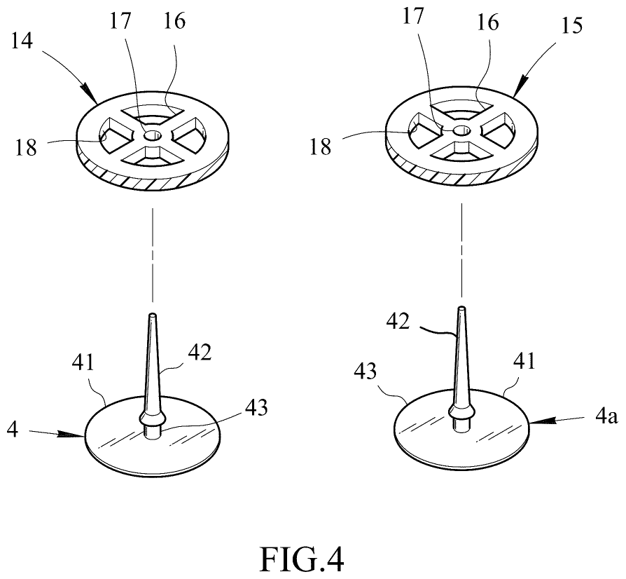

A first connecting hole 14 is configured inside the first passage 11 at a position adjacent to an outer opening 111, and a second connecting hole 15 is configured inside the second passage 12 at a position adjacent to the intersection 13, as shown in FIG. 3 and FIG. 4. The first connecting hole 14 and the second connecting hole 15 are respectively configured with at least three ribs 16 forming a bore hole 17 in the center of the respective passages, and a plurality of through holes 18 around the bore hole 17.

The biting piece 2 is connected to an inner opening 112 of the first passage 11 of the main body 1 through male and female sleeve joint or threaded connection. The biting piece 2 is provided for biting by the mouth of a person to facilitate breathing through the mouth.

The extension tube 3 is also connected to the opening 121 of the second passage 12 of the main body 1 through male and female sleeve joint or threaded connection. An air inlet 32 of the extension tube 3 can be extended to the outside for the person to breathe clean air from an area without dense smoke. In addition, between the extension tube 3 and the outer end of the second passage 12 of the main body 1, a flexible tube 31 is configured. The flexible tube 31 allows flexible adjustment of the extension tube 3 in different angles, so that the person can easily move the extension tube 3 in various angles in relation to the main body 1. It is to be noted that, the air inlet 32 on the outermost end of the extension tube 3 can be connected with a filtering tank 5 for circumstances where the air inlet 32 of the extension tube 3 cannot be extended to an area without dense smoke.

As depicted in FIG. 4 to FIG. 6, the exhalation valve 4 is connected on the outer end face of the first connecting hole 14 of the main body 1. The exhalation valve 4 is provided for open/close control of the first passage 11, i.e., when the person exhales, the exhalation valve 4 opens the first passage 11, and when the person inhales, the exhalation valve 4 closes the first passage 11.

Similarly, the suction valve 4a is connected to the inner end face of the second connecting hole 15 of the main body 1. The suction valve 4a is provided for open/close control of the second passage 12, i.e., when the person inhales, the suction valve 4a opens the second passage 12, and when the person exhales, the suction valve 4a closes the second passage 12.

Referring further to FIG. 3 and FIG. 4, both the exhalation valve 4 and the suction valve 4a are formed as a diaphragm 41 with its center configured with a conic inserting rod 42 extending outward. An outstanding flange 43 is configured on the inserting rod 42 at a position close to the diaphragm 41.

Specifically, the inserting rod 42 is to be inserted into the bore hole 17 configured inside the first connecting hole 14 or the second connecting hole 15. After the outstanding flange 43 passes through the bore hole 17, a short section of the rod between the outstanding flange 43 and the diaphragm 41 is locked inside the bore hole 17. Thus, the exhalation valve 4 and the suction valve 4a can be respectively fixed on the outer end face of the first connecting hole 14 and the inner end face of the second connecting hole 15, and the diaphragms 41 of the exhalation valve 4 or the suction valve 4a can completely cover the through holes 18 around the bore hole 17 inside the first connecting hole 14 or the second connecting hole 15. Through such a configuration, the exhalation valve 4 and the suction valve 4a neighboring each other can work interactively as one-way check valves in opposite directions, so that people escaping from the fire ground can breathe smoothly and avoid repeated intake of carbon dioxide exhaust gas.

Therefore, referring to FIG. 1, the emergency escape breathing device for use in fire ground A disclosed in the present invention is usually put inside a box and displayed at a prominent place inside a building for easy access. In case of fire, to use the product in the fire ground, firstly extend the air inlet 32 of the extension tube 3 to an area without dense smoke so that the person can breathe clean air. Then, put the biting piece 2 into the mouth and grip it with teeth. Now, through the cyclic interactive breathing function of the main body 1, the person can inhale clean air from the area to which the extension tube 3 is extended, and exhale carbon dioxide from inside the human body. The head strap 6 can be used to wear the product on the head.

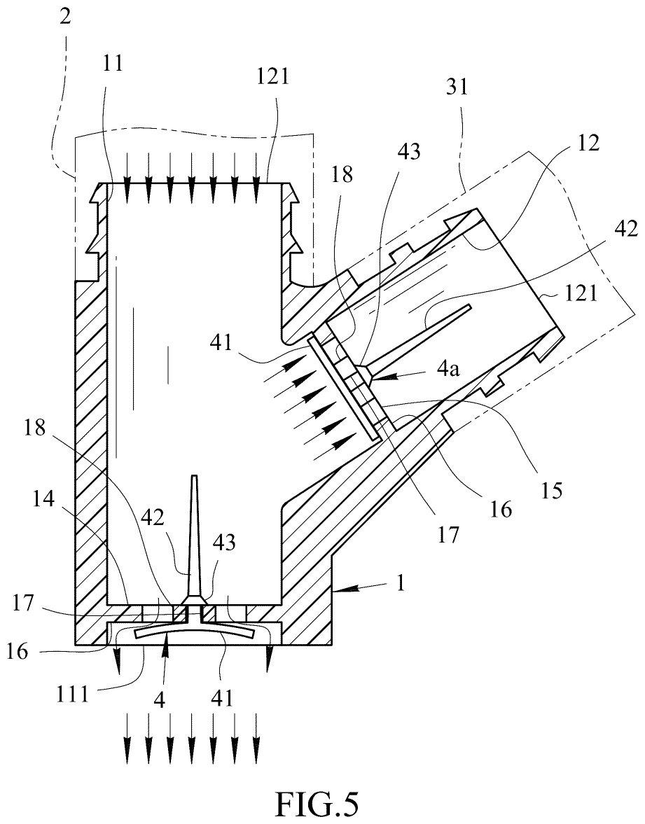

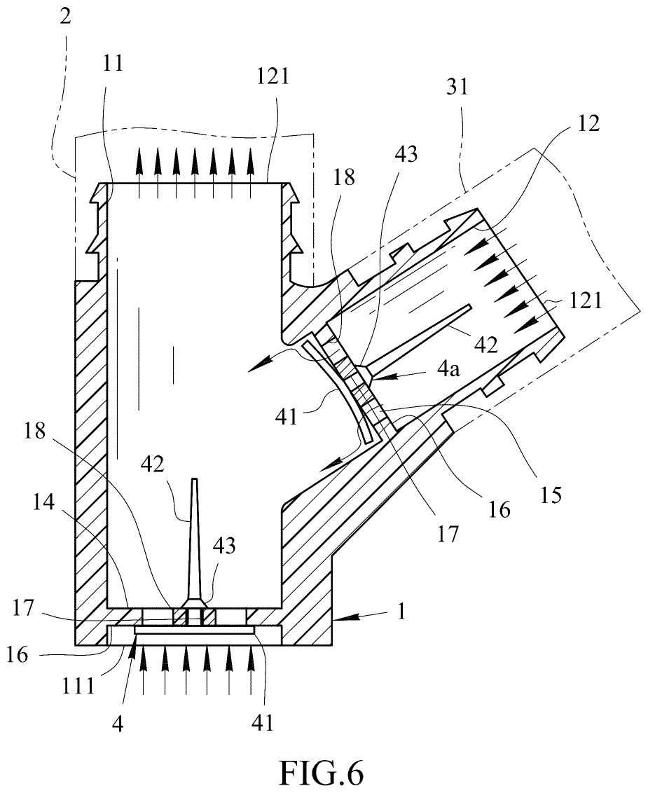

Specifically, the interactive breathing function of the main body 1 is shown in FIG. 5 and FIG. 6. When the mouth bites the biting piece 2 for inhalation, the gas inside the main body 1 will all flow to the biting piece 2, generating a sucking force, causing the exhalation valve 4 to close the first passage 11, whereas the suction valve 4a to open the second passage 12 for the clean air inside the extension tube 3 to flow into the main body 1, and then to the biting piece 2. Thus, the mouth can intake clean air.

Similarly, when the mouth bites the biting piece 2 for exhalation, the gas inside the main body 1 will all flow to the outer opening 111 of the first passage 11, generating a pushing force, causing the exhalation valve 4 to open the first passage 11, whereas the suction valve 4a to close the second passage 12, thus stopping the clean air inside the extension tube 3 from entering the main body 1, to allow the carbon dioxide exhaled from the mouth can flow out smoothly from the outer opening 111 of the first passage 11. Through such a cyclic interactive breathing function, the person in the fire ground can breathe clean air by using the present invention of an emergency escape breathing device for use in fire ground A, which enables the person to escape from the fire ground or to survive for a longer time before being rescued.

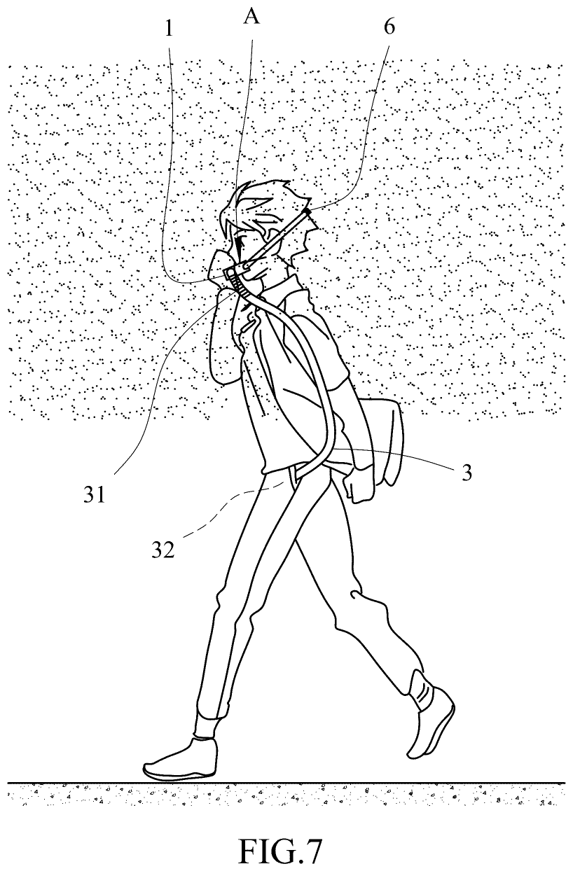

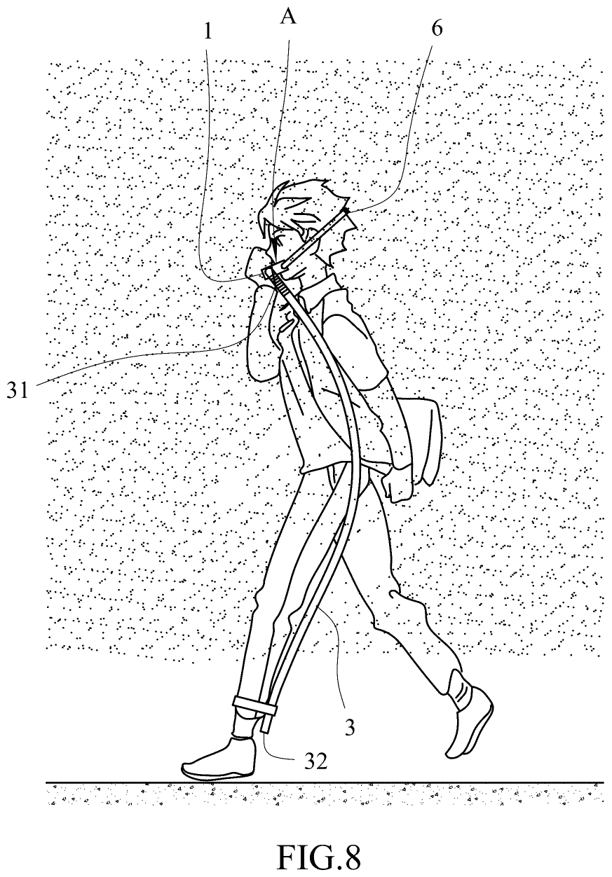

FIG. 7 to FIG. 10 show the applications of the present invention of an emergency escape breathing device. First referring to FIG. 7, when the dense smoke in the fire ground only permeate the upper indoor space, the user can put the air inlet 32 of the extension tube 3 into the pocket of the trousers, so that the tip end of the extension tube 3 is located in an area with clean air below the upper space permeated with dense smoke. Meanwhile, the user can use one hand to hold the nose, and breathe clean air by the mouth while escaping. Similarly, as shown in FIG. 8, when the dense smoke in the fire ground has already permeated the whole indoor space, the user can wrap the air inlet 32 of the extension tube 3 on the ankle, so that the air inlet 32 is located in the area of clean air at the bottom of the indoor space, and use one hand to hold the nose, and breathe clean air using mouth while escaping.

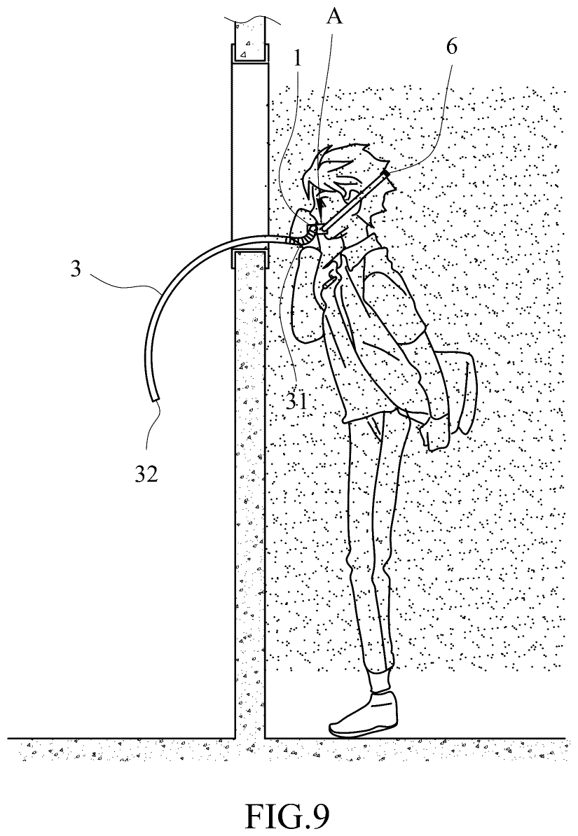

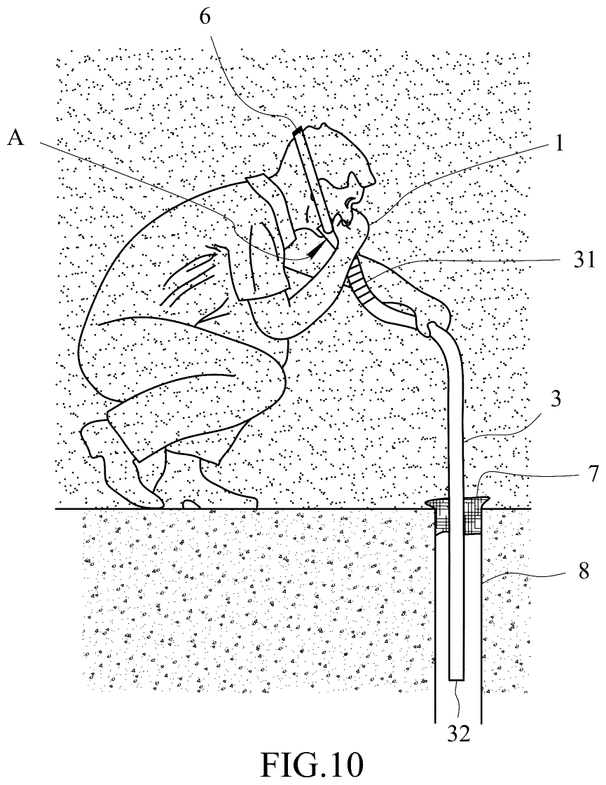

Further, in case there is a window nearby the person in the fire ground, as shown in FIG. 9, the user can firstly break the glass of the window, and extend the tip end of the extension tube 3 out of the window till it is far from the window, hold the nose with one hand to use the mouth to breathe clean air from out of the window, and wait for rescue. Similarly, in case there is a drainage pipe (e.g., the water discharge port connecting the drainage pipe 8 in the bathroom) or an air exhaust port (e.g., the air exhaust port on the ceiling of the bathroom) nearby the user in the fire ground, as shown in FIG. 10, the user can insert the tip end of the air inlet 32 of the extension tube 3 into the water discharge port of the drainage pipe 8 or the air exhaust port, and use a wet cloth 7 to seal the entrance of the water discharge port of the drainage pipe 8 or the air exhaust port. Meanwhile, use the left hand to hold the extension tube 3, and the right hand to hold the nose, so as to inhale clean air from the pipes of the building, to gain time for rescue.

Please refer to FIG. 2 again. It is to be noted that, when assembling the suction valve 4a of the present invention, in case the main body 1 is an integrally formed single body, firstly, the suction valve 4a can be placed in from the inner opening 112 of the first passage 11, then, the suction valve 4a can be mounted on the inner end face of the second connecting hole 15; in case the main body 1 is implemented as a two-component structure, the suction valve 4a can be firstly mounted on the inner end face (indicated by a dashed line in FIG. 2) of the second connecting hole 15, and then couple the two components. Preferably, the main body 1 is integrally formed through injection molding using a transparent or semitransparent plastic material, so that workers can see the assembly from outside, thus facilitating assembly of the suction valve 4a on the inner end face of the second connecting hole 15. On the other hand, if the main body 1 is implemented as a two-component structure, it is not necessarily made of a transparent material.

1. An emergency escape breathing device for use in a fire ground, comprising:
a main body, configured with a first passage and a second passage, wherein the first passage and the second passage are both connected to an intersection, and the inside of the outer end of the first passage is configured with a first connecting hole, while the second passage is configured with a second connecting hole at a position adjacent to the intersection;
a biting piece, connected to the inner end of the first passage of the main body, for biting by the mouth of a person;
an extension tube, connected to the outer end of the second passage of the main body, for extension to the outside to breathe clean air from an area without dense smoke;
an exhalation valve, connected to the outer end face of the first connecting hole of the main body, to open/close the first passage, i.e., open the first passage when the user exhales, and close the first passage when the user inhales; and
a suction valve, connected to the inner end face of the second connecting hole of the main body, to open/close the second passage, i.e., open the second passage when the user inhales, and close the second passage when the user exhales.

2. The emergency escape breathing device for use in a fire ground defined in claim 1, wherein said extension tube can be connected with a filtering tank.

3. The emergency escape breathing device for use in a fire ground defined in claim 1, wherein said main body is attached with a head strap.

4. The emergency escape breathing device for use in a fire ground defined in claim 1, wherein a flexible tube is configured between the extension tube and the outer end of the second passage of the main body.

5. The emergency escape breathing device for use in a fire ground defined in claim 4, wherein said first connecting hole and the second connecting hole are formed by at least three ribs and a bore hole formed in the center of the passage.

6. The emergency escape breathing device for use in a fire ground defined in claim 5, wherein said exhalation valve and suction valve are both formed as a diaphragm with its center configured with a conic inserting rod extending outward, and an outstanding flange is configured on the inserting rod at a position close to the diaphragm.

7. The emergency escape breathing device for use in a fire ground defined in claim 1, wherein, when the main body is implemented as an integrally formed single body, firstly the suction valve can be placed in from the inner opening of the first passage, and then the suction valve can be mounted on the inner end face of the second connecting hole; and the main body is integrally formed through injection molding using a transparent plastic material.

8. The emergency escape breathing device for use in a fire ground defined in claim 1, wherein, when the main body is implemented as a two-component structure, firstly the suction valve can be mounted on the inner end face of the second connecting hole, and then the two components can be coupled together.

9. The emergency escape breathing device for use in a fire ground defined in claim 2, wherein a flexible tube is configured between the extension tube and the outer end of the second passage of the main body.

10. The emergency escape breathing device for use in a fire ground defined in claim 3, wherein a flexible tube is configured between the extension tube and the outer end of the second passage of the main body.
